(19) United States
(12) Patent Application Publication
(10) Pub. No.: US 2007/0251788 A1
(43) Pub. Date: Nov. 1, 2007

(54) Drive plate and seal for a torque converter

(75) Inventors: Thomas Heck, Wooster, OH (US); Scott Schrader, Canton, OH (US)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/788,278

(22) Filed: Apr. 19, 2007

Related U.S. Application Data
(60) Provisional application No. 60/796,429, filed on May 1, 2006.

(51) Int. Cl. F16H 45/02

(52) U.S. Cl. 192/3.3; 192/3.29

(57) ABSTRACT

A clutch assembly in a torque converter including a piston plate operatively arranged to apply axial pressure to a clutch in the clutch assembly. An annular member can be rotationally connected to a cover of the torque converter and rotationally connected to an outer circumference of the clutch. A first seal can be disposed between the piston plate and an inner circumference of the drive plate to form a seal between the piston plate and the inner circumference. In some aspects, the annular member is a drive plate arranged to transmit torque from said cover to said clutch and the annular member is fixedly secured to said cover by a weld. In other aspects, the first clutch plate is axially displaceable with respect to the annular member and the piston plate is axially displaceable with respect to the annular member.

### CROSS-REFERENCE TO RELATED APPLICATIONS

This application claims the benefit under 35 U.S.C. §119(e) of U.S. Provisional Application No. 60/796,429 filed May 1, 2006.

### FIELD OF THE INVENTION

The invention relates generally to a seal for a torque converter, and, more particularly, to a drive plate member that interacts with a slipping clutch, and seals the piston plate.

### BACKGROUND OF THE INVENTION

It is well known that a torque converter is used to transmit torque from an engine to a transmission of a motor vehicle. FIG. 1 illustrates a general block diagram showing the relationship of the engine 7, torque converter 10, transmission 8, and differential/axle assembly 9 in a typical vehicle.

The three main components of the torque converter are the pump 37, turbine 38, and stator 39. The torque converter becomes a sealed chamber when the pump is welded to cover 11. The cover is connected to flexplate 41 which is, in turn, bolted to crankshaft 42 of engine 7. The cover can be connected to the flexplate using lugs or studs welded to the cover. The welded connection between the pump and cover transmits engine torque to the pump. Therefore, the pump always rotates at engine speed. The function of the pump is to use this rotational motion to propel the fluid radially outward and axially towards the turbine. Therefore, the pump is a centrifugal pump propelling fluid from a small radial inlet to a large radial outlet, increasing the energy in the fluid. Pressure to engage transmission clutches and the torque converter clutch is supplied by an additional pump in the transmission that is driven by the pump hub.

In torque converter 10 a fluid circuit is created by the pump (sometimes called an impeller), the turbine, and the stator (sometimes called a reactor). The fluid circuit allows the engine to continue rotating when the vehicle is stopped, and accelerate the vehicle when desired by a driver. The torque converter supplements engine torque through torque ratio, similar to a gear reduction. Torque ratio is the ratio of output torque to input torque. Torque ratio is highest at low or no turbine rotational speed (also called stall). Stall torque ratios are typically within a range of 1.8-2.2. This means that the output torque of the torque converter is 1.8-2.2 times greater than the input torque. Output speed, however, is much lower than input speed, because the turbine is connected to the output and it is not rotating, but the input is rotating at engine speed.

Turbine 38 uses the fluid energy it receives from pump 37 to propel the vehicle. Turbine shell 22 is connected to turbine hub 19. Turbine hub 19 uses a spline connection to transmit turbine torque to transmission input shaft 43. The input shaft is connected to the wheels of the vehicle through gears and shafts in transmission 8 and axle differential 9. The force of the fluid impacting the turbine blades is output from the turbine as torque. Axial thrust bearings 31 support the components from axial forces imparted by the fluid. When output torque is sufficient to overcome the inertia of the vehicle at rest, the vehicle begins to move.

After the fluid energy is converted to torque by the turbine, there is still some energy left in the fluid. The fluid exiting from small radial outlet 44 would ordinarily enter the pump in such a manner as to oppose the rotation of the pump. Stator 39 is used to redirect the fluid to help accelerate the pump, thereby increasing torque ratio. Stator 39 is connected to stator shaft 45 through one-way clutch 46. The stator shaft is connected to transmission housing 47 and does not rotate. One-way clutch 46 prevents stator 39 from rotating at low speed ratios (where the pump is spinning faster than the turbine). Fluid entering stator 39 from turbine outlet 44 is turned by stator blades 48 to enter pump 37 in the direction of rotation.

The blade inlet and exit angles, the pump and turbine shell shapes, and the overall diameter of the torque converter influence its performance. Design parameters include the torque ratio, efficiency, and ability of the torque converter to absorb engine torque without allowing the engine to “run away.” This occurs if the torque converter is too small and the pump can't slow the engine.

At low speed ratios, the torque converter works well to allow the engine to rotate while the vehicle is stationary, and to supplement engine torque for increased performance. At high speed ratios, the torque converter is less efficient. The torque ratio of the torque converter gradually reduces from a high of about 1.8 to 2.2, to a torque ratio of about 1 as the turbine rotational speed approaches the pump rotational speed. Torque ratio of 1 is called the coupling point. At this point, the fluid entering the stator no longer needs redirected, and the one way clutch in the stator allows it to rotate in the same direction as the pump and turbine. Because the stator is not redirecting the fluid, torque output from the torque converter is the same as torque input. The entire fluid circuit will rotate as a unit.

Maximum torque converter efficiency is limited to 92-93% based on losses in the fluid. Therefore torque converter clutch 49 is employed to mechanically connect the torque converter input to the output, improving efficiency to near 100%. Clutch piston plate 17 is hydraulically applied when commanded by the transmission controller. Piston plate 17 is sealed to turbine hub 19 at its inner diameter by o-ring 18 and to cover 11 at its outer diameter by friction material ring 51. These seals create a pressure chamber and force piston plate 17 into engagement with cover 11. This mechanical connection bypasses the torque converter fluid circuit.

The mechanical connection of torque converter clutch 49 transmits many more engine torsional fluctuations to the drivetrain. As the drivetrain is basically a spring-mass system, torsional fluctuations from the engine can excite natural frequencies of the system. A damper is employed to shift the drivetrain natural frequencies out of the driving range. The damper includes springs 15 in series to lower the effective spring rate of the system, thereby lowering the natural frequency.

Torque converter clutch 49 generally comprises four components: piston plate 17, cover plates 12 and 16, springs 15, and flange 13. Cover plates 12 and 16 transmit torque from piston plate 17 to compression springs 15. Cover plate wings 52 are formed around springs 15 for axial retention. Torque from piston plate 17 is transmitted to cover plates 12 and 16 through a riveted connection. Cover plates 12 and 16 impart torque to compression springs 15 by contact with an edge of a spring window. Both cover plates work in combination to support the spring on both sides of the spring center axis. Spring force is transmitted to flange 13 by contact with a flange spring window edge. Sometimes the flange also has a rotational tab or slot which engages a portion of the cover plate to prevent over-compression of the springs during high torque events. Torque from flange 13 is transmitted to turbine hub 19 and into transmission input shaft 43.

Energy absorption can be accomplished through friction, sometimes called hysteresis, if desired. Hysteresis includes friction from windup and unwinding of the damper plates, so it is twice the actual friction torque. The hysteresis package generally consists of diaphragm (or Belleville) spring 14 which is placed between flange 13 and one of cover plates 16 to urge flange 13 into contact with the other cover plate 12. By controlling the amount of force exerted by diaphragm spring 14, the amount of friction torque can also be controlled. Typical hysteresis values are in the range of 10-30 Nm.

Some torque converters implement a clutch pack consisting of several clutch plates. The current design of such multi-plate torque converter clutches feature a driven plate member located radially outside of the clutch plates. A second plate welded to the cover acts as a seal member that engages a portion of the piston plate. (e.g., U.S. Pat. No. 6,264,018 (Matsuoka).

FIG. 7 is a cross-sectional view of torque converter 110, embodying one configuration of a torque converter with a continuous slip clutch with drive plate 112 attached to front cover 116. Drive plate 112 is conventionally attached to front cover 116 using a laser weld or some other attachment means known in the art. Weld 122 indicates the typical location of the welding point used to attach drive plate 112 to front cover 116. Drive plate 112 can be an annular stamped component having an L-shaped cross section profile comprised of sheet steel. Outer clutch plates 124 and 130 and inner clutch plate 128 are associated with drive plate 112 at the outer circumference of the plates, where drive plate 112 functions as a retaining means for these clutch plates. Clutch plates 132 are associated with damper plate 138 at the inner circumference of the plates. Clutch plates 124, 128 and 130 are driven axially by drive plate 112 to interact with inner clutch plates 132. Consequently, torque is transmitted by frictional engagement of clutch plates 124, 128 and 132 with clutch plates 132, and the rotational connection of clutch plates 132 to damper 138 transfers torque. Clutch plates 124, 128, 130 and 132 can be manufactured from sheet steel and include friction paper 126 on the contact surfaces of the clutch plates. Clutch plates 124, 128, 130 and 132 comprise the clutch pack, where clutch plates 124, 128, 130 are retained by drive plate 112 on the outer circumference of the clutch plates with the assistance of retaining ring 134. The clutch plates of the clutch pack are disposed on drive plate 112 and damper plate 138 in such a way to facilitate the axial displacement of individual clutch plates to enable the clutch plates to be acted upon by axial displacement of piston plate 118. Axial displacement among the clutch plates permits the clutch pack to engage or disengage, i.e., bypass the torque converter fluid circuit or not.

Piston plate 118 with apply side 158 and release side 156, is the component that transfers torque generated in the pressure chamber to clutch plates 124, 128, 130 and 132. Pressure developed on apply side 158 of piston plate 118 in the pressure chamber causes the piston plate to move axially toward clutch plate 124, which in turn transfers torque to the clutch pack and bypasses the fluid circuit in the torque converter. Fluid pumped by a pump in the transmission is directed to the pressure chamber that axially moves piston plate 118 to engage the clutch pack, which ultimately bypasses the fluid circuit in the torque converter. Sealing member 114 engages piston plate 118 to form a pressure chamber that enables fluid pumped into the chamber on the apply side of the piston plate to axial move the piston plate to facilitate the bypass of the fluid circuit.

Sealing member 114 can be welded to front cover 116 in any method known in the art Sealing member 114 is an annular element with an L-shaped cross section profile. O-ring 120, placed between the underside of sealing member 114 and piston plate 118, is one method of sealing pressure and fluid inside the pressure chamber formed on apply side 158 of piston plate 118. The arrangement shown in FIG. 7 is the conventional method of sealing the piston plate, wherein a separate sealing member, such as sealing member 114 is implemented.

Contemporary multi-plate torque converter clutches require second plate 114 rotationally connected to front cover 116, typically by a weld, to seal the pressure chamber behind the piston plate. Requiring a separate plate to seal the piston plate increases the material costs since additional steel is needed to make the second plate. Moreover, the time needed to weld a second plate to the torque converter cover increases manufacturing time and increases the complexity of the torque converter manufacturing process. The formation of a second sealing plate is one area that results in additional manufacturing time. Also, the time needed to weld the second plate to the cover is additional waste that could be eliminated if the second sealing plate could be rendered superfluous.

Thus, there is a long-felt need to provide a sealing member for the apply side of a piston plate in a torque converter that can eliminate the need for a separate second sealing plate. There is a further need for a piston plate sealing member that can reduce the complexity, costs, assembly time, and overall manufacturing costs for a piston plate sealing member by providing a drive plate that can simultaneously seal the apply side of the piston plate and associate with the clutch plates on a multi-plate torque converter clutch.

### SUMMARY OF THE INVENTION

The invention broadly comprises a clutch assembly in a torque converter including a piston plate operatively arranged to apply axial pressure to a clutch in the clutch assembly. An annular member can be rotationally connected to a cover of the torque converter and rotationally connected to an outer circumference of the clutch. A first seal can be disposed between the piston plate and an inner circumference of the drive plate to form a seal between the piston plate and the inner circumference. In some aspects, the annular member is a drive plate arranged to transmit torque from said cover to said clutch, and the annular member is fixedly secured to said cover by a weld. The clutch assembly can further comprise a first clutch plate with an outer circumference where the annular member is rotationally connected to the first clutch plate proximate the outer circumference. In some aspects, the first clutch plate is axially displaceable with respect to the annular member and the piston plate is axially displaceable with respect to the annular member. The clutch can be a continuous slip clutch with a plurality of second clutch plates where the plurality of second clutch plates is axially displaceable with respect to the annular member. The piston plate can further comprise an inner circumferential end where the torque converter further comprises a space between the cover and the piston plate and a second seal is disposed proximate the inner circumferential end, where the first and second seals substantially seal the space. The torque converter can be arranged to modify pressure in the space to axially displace the piston plate. The seal can be selected from the group consisting of a U-shaped seal and an L-shaped seal, where the said seal can be rubber or an o-ring.

The invention also broadly comprises a drive plate for a clutch in a torque converter which includes an axially disposed segment rotationally connected to an outer circumference of the clutch and rotationally connected to a cover for the torque converter. A sealing element can be disposed between the inner circumferential end of the drive plate and a piston plate that is engage with the clutch, where a seal is formed between a seal the inner circumferential end and the piston plate. In some aspects, the drive plate is arranged to transmit torque from the cover to the clutch and the piston plate is arranged to axially engage the clutch.

The invention further comprises a clutch assembly in a torque converter which includes a piston plate operatively arranged to apply axial pressure to a clutch in the clutch assembly. Also, a drive plate with an inner circumference can be fixedly secured to a cover of the torque converter and rotationally connected to an outer circumference of at least one clutch plate in the clutch, and comprising an inner circumference. A seal can be disposed between the piston plate and the inner circumference of the drive plate and in contact with the piston plate and the inner circumference of the drive plate, where the piston plate is axially displaceable with respect to the annular member.

It is a general object of the present invention to provide a torque converter with a drive plate and piston plate sealing member that eliminates manufacturing costs and time.

It is another object of the present invention to provide a torque converter that combines the tasks of a drive plate and piston plate sealing member into one component.

These and other objects and advantages of the present invention will be readily appreciable from the following description of preferred embodiments of the invention and from the accompanying drawings and claims.

### BRIEF DESCRIPTION OF THE DRAWINGS

FIG. 1 is a general block diagram illustration of power flow in a motor vehicle, intended to help explain the relationship and function of a torque converter in the drive train thereof;

FIG. 2 is a cross-sectional view of a prior art torque converter, shown secured to an engine of a motor vehicle;

FIG. 3 is a left view of the torque converter shown in FIG. 2, taken generally along line 3-3 in FIG. 2;

FIG. 4 is a cross-sectional view of the torque converter shown in FIGS. 2 and 3, taken generally along line 4-4 in FIG. 3;

FIG. 5 is a first exploded view of the torque converter shown in FIG. 2, as shown from the perspective of one viewing the exploded torque converter from the left;

FIG. 6 is a second exploded view of the torque converter shown in FIG. 2, as shown from the perspective of one viewing the exploded torque converter from the right;

FIG. 7 is a partial cross-sectional view of a torque converter with a multi-plate clutch;

FIG. 8 is a partial cross-sectional view of a torque converter with a multi-plate clutch of the present invention;

FIG. 9 is an enlarged cross-sectional view of a torque converter, similar to that shown in FIG. 8, taken generally from the region designated as circle 9 and 10 shown in FIG. 8, showing the present invention; and,

FIG. 10 is an enlarged cross-sectional view of a torque converter, similar to that shown in FIG. 8, taken generally from the region designated as circle 9 and 10 shown in FIG. 8, showing an alternative embodiment of the present invention.

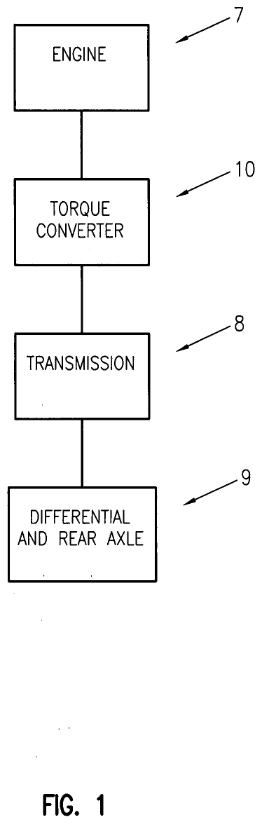

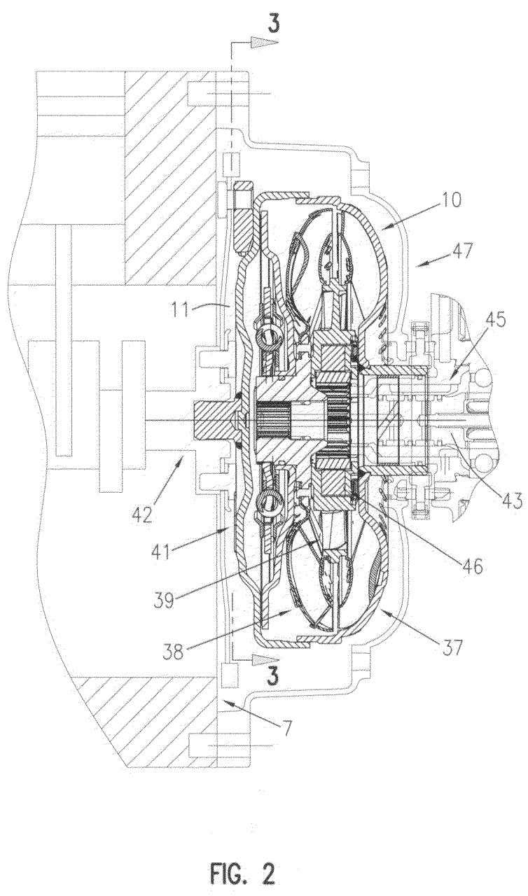

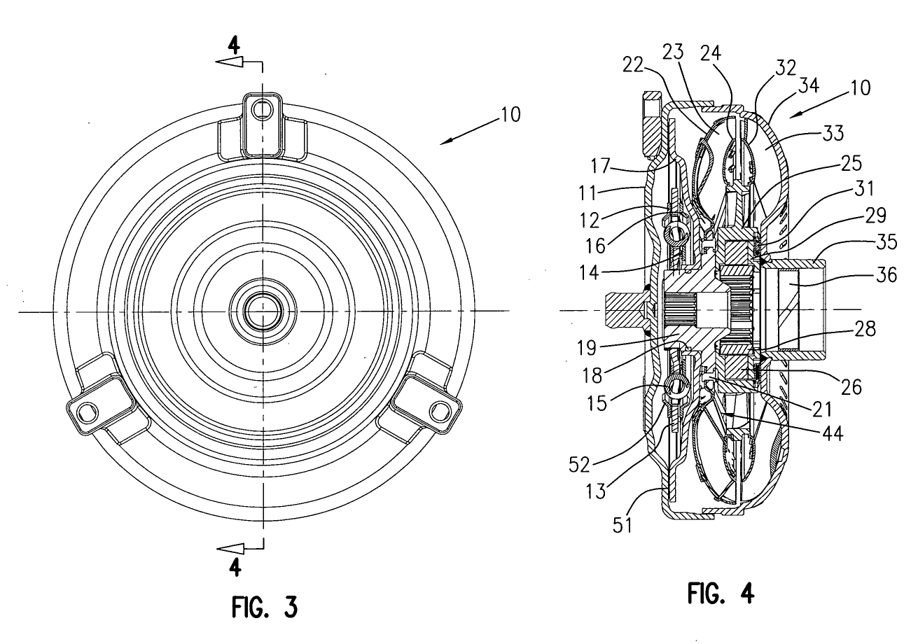

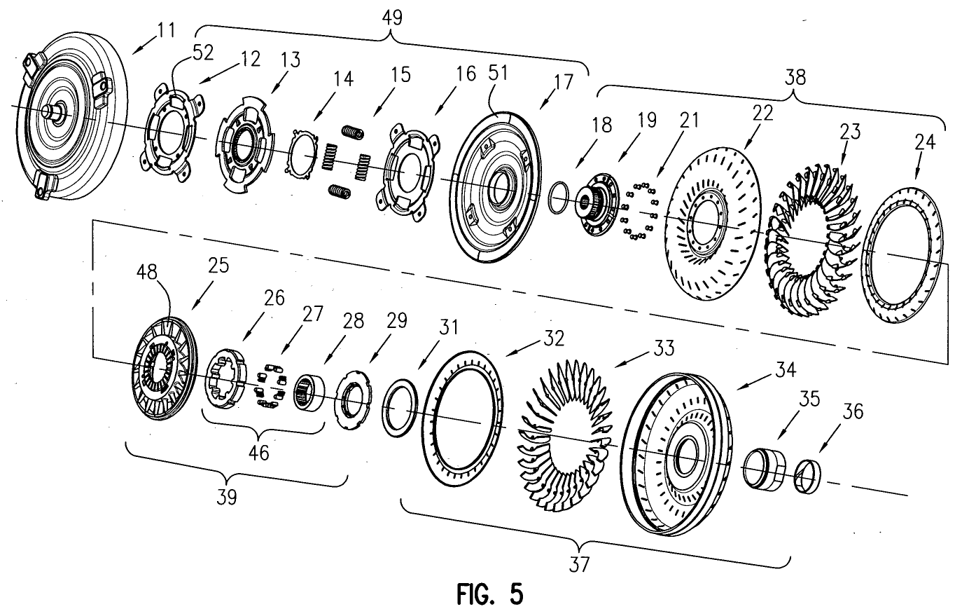

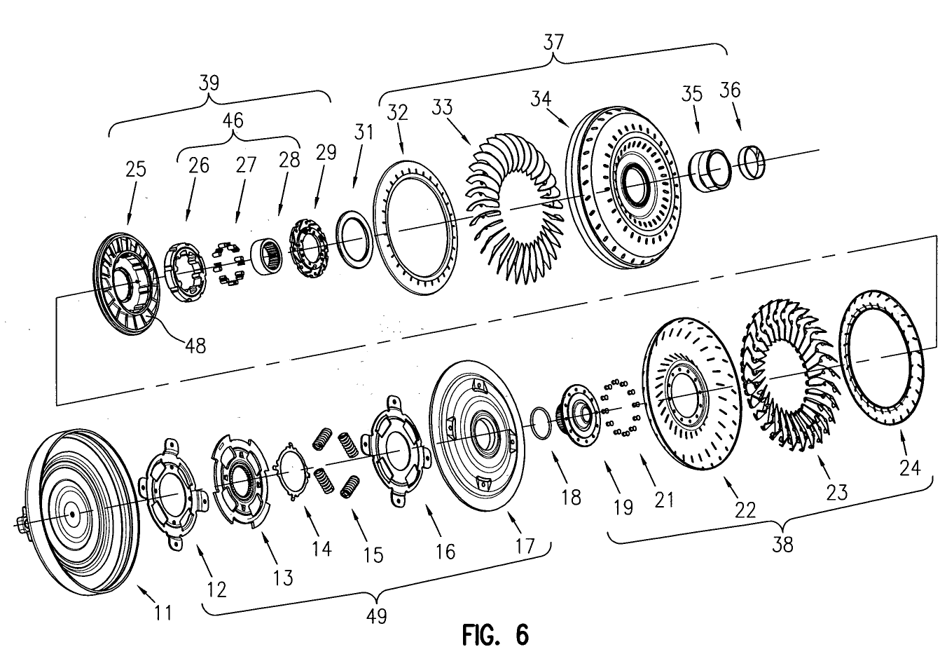

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

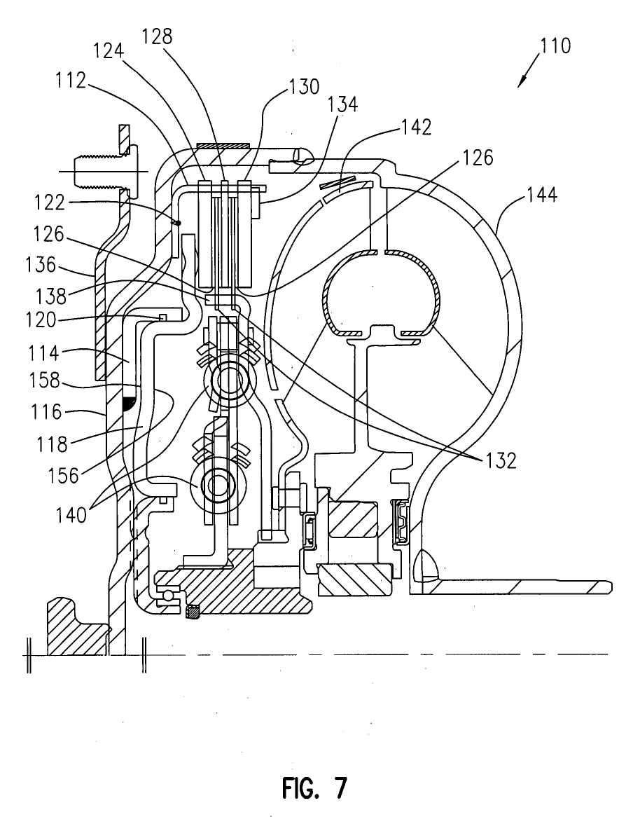

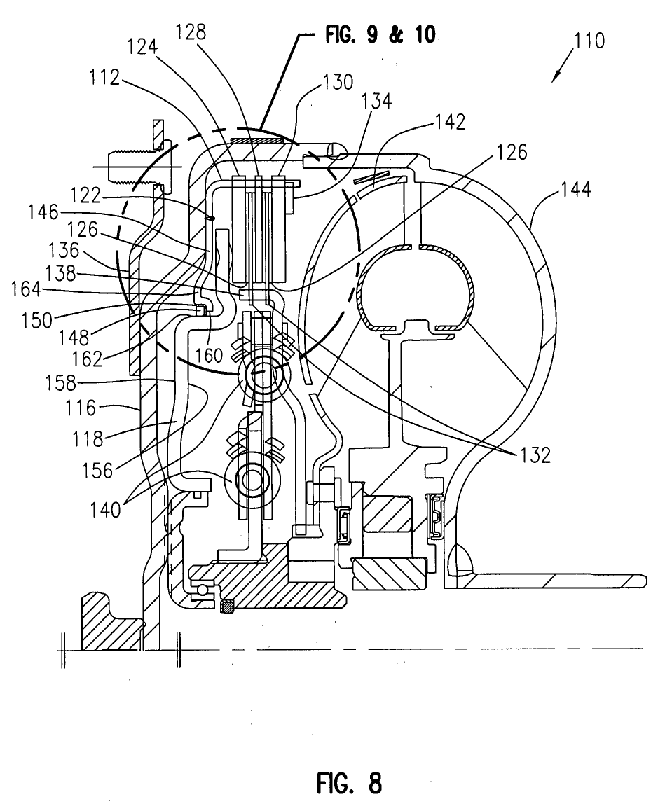

FIG. 8 is a vertical cross-sectional view of torque converter 110 of the present invention. In this view, sealing member 114 and drive plate 112 (both shown in FIG. 7) have been eliminated. The sealing member 114 and drive plate 112 have been replaced by drive plate 146 that extends toward the center of front cover 116 to surface 162 of piston plate 118. The functions of both elements, sealing member 114 and drive plate 112, are accomplished by a single element, drive plate 146. Drive plate 146 is rotationally connected to front cover 116 and rotationally connected to the outer circumference of the clutch shown represented by clutch plates 124, 128, 130 and 132. Specifically, drive plate 146 is rotationally connection to the outer circumference of clutch plates 124, 128 and 130, and damper plate 138 is rotationally connected to clutch plates 132. As clutch plates 124, 128 and 130 are compressed axially, friction between plates 124, 128 and 130 acting upon clutch plates 132 transfers torque to damper plate to 138.

By rotationally connected, or secured, we mean that the plate and the shell are connected such that the two components rotate together, that is, the two components are fixed with respect to rotation. Rotationally connecting two components does not necessarily limit relative movement in other directions. For example, it is possible for two components that are rotationally connected to have axial movement with respect to each other via a spline connection. However, it should be understood that rotational connection does not imply that movement in other directions is necessarily present. For example, two components that are rotationally connected can be axially fixed one to the other. The preceding explanation of rotational connection is applicable to the discussions infra. In the discussions infra, a connection is assumed to be a rotational connection unless otherwise specified.

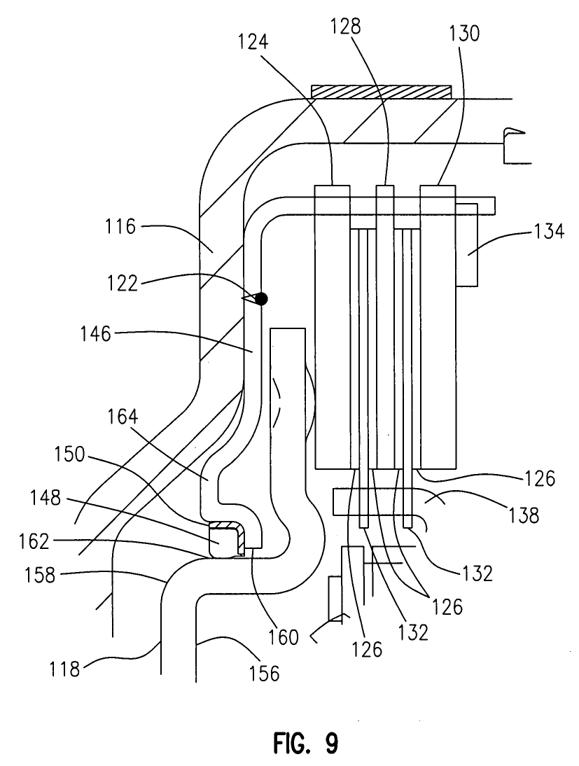

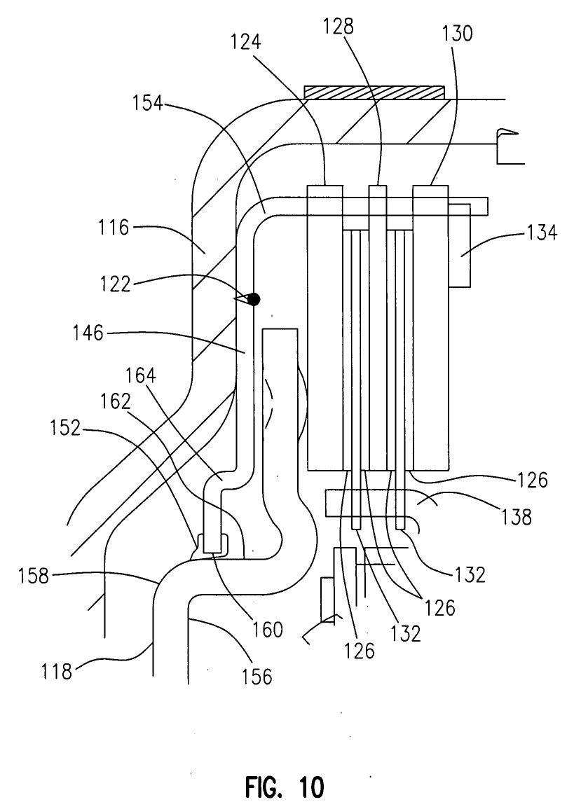

The seal on drive plate 146 that facilitates the sealing of the pressure chamber behind apply side 158 of piston plate 118 can be performed by any seal known in that art. Represented in FIGS. 8 and 9 by members 148, 150, and in FIG. 10 by lip seal 152 are two possible sealing candidates. It should be understood that the seal between drive plate inner circumferential end 160 and piston plate 162 can include, but is not limited to sealing members 148, 150 and 152, i.e., other alternative sealing means known in the art can be substituted for the sealing means shown and described. In some aspects, drive plate 146 is also associated with the clutch plates of the continuous slip clutch assembly at a position distal to inner circumferential end 160. Disposing sealing element 148, 150 or 152 at inner circumferential end 160 of the drive plate, and the clutch plates at an end distal to the periphery of drive plate 146, enables drive plate 146 to interact with the clutch plates and piston plate 118 simultaneously.

The pressure chamber formed by interaction between inner circumferential end 160 of drive plate 146 and surface 162 of piston plate 118 enables fluid pressure to be generated on apply side 158 of piston plate 118. It is this fluid pressure that is generated in the pressure chamber by a separate pump connected to the transmission that can force piston plate 118 to move axially toward clutch plates 124, 128, 130 and 132. If enough pressure is generated in the pressure chamber on apply side 158, piston plate 118 will fully engage the clutch plates and the torque converter fluid circuit will be bypassed. As pressure in the pressure chamber on apply side 158 is decreased, piston plate 118 displaces axially away from clutch plates 124, 128, 130 and 132, which in turn disengages the clutch and stops the bypass of the torque converter fluid circuit. The seal at inner circumferential end 160 of drive plate 146 remains in constant contact with surface 162 of piston plate 118 as this axial movement of piston plate 118 occurs. The interaction between the seal at inner circumferential end 160 and surface 162 prevents the loss of pressure and fluid from the pressure chamber, and facilitates the transfer of fluid pressure on apply side 158 to piston plate 118, which cause frictional engagement of the clutch plates to cause bypass of the fluid circuit in the torque converter. The interaction of the sealed inner circumferential end 160 of drive plate 146 can be a frictional engagement, and preferably the interaction should allow axial movement of piston plate 118.

FIG. 9 is an enlarged cross-sectional view of drive plate 146 that seals apply side 158 of piston plate 118 of the present invention. Drive plate 146 has the dual function of retaining and associating at the outer circumference of clutch plates 124, 128, 130 and indirectly 132, and sealing apply side of piston plate 118. The number of clutch plates of the continuous slip clutch assembly shown is variable. It is within the spirit and scope of the present invention to have one clutch plate or a plurality of clutch plates associated with drive plate 146. The clutch plates of the conventional multi-plate torque converter clutch shown in FIG. 7 are similar to the clutch plates of the embodiment shown in FIGS. 8, 9 and 10, and thus identical reference numbers have been used. This is true of other elements of the torque converter of the present invention that are similar to the contemporary torque converter shown in FIG. 7 in that parts that are similar in FIGS. 8, 9 and 10 have retained the reference numbers used in FIG. 7.

Drive plate 146 is an annular component formed from a sheet steel blank that has been stamped into a plate having a L-shaped cross section profile. This configuration is only one possible shape for drive plate 146, and variations in shape of this element are considered within the spirit and scope of the instant invention. Where previous drive plates were welded to front cover 116 and remain flush with the interior surface of front cover 116 and did not extend to surface 162 of piston plate 118, drive plate 146 of the instant invention extends toward the center axis of front cover 116 to surface 162 of piston plate 118. By extending drive plate 146 to surface 162 of piston plate 118, separate sealing member 114 (shown in FIG. 7) can be eliminated, thus resulting in a reduction of material costs and production time. Eliminating sealing member 114 reduces production time by doing away with the manufacturing steps of forming sealing member 114 and attaching the sealing member to front cover 116. Drive plate 112 (shown in FIG. 7) and drive plate 146 of the current invention are attached to front cover 116 in a similar fashion, i.e., welding. Thus, by consolidating the tasks of the drive plate and piston sealing member into one component 146, the step of welding a separate sealing member is completely eliminated and manufacturing time is reduced and material costs are reduced.

Drive plate 146 seals piston plate 118 with ring 150, which has an L-shaped cross section, and o-ring 148. The L-shape of ring 150 creates a lip that retains o-ring 148. The combination of ring 150 and o-ring 148 forms a seal against surface 162 of piston plate 118 that prevents leakage of fluid from the pressure chamber on apply side 158 of piston plate 118. In the sealing method shown in FIG. 9, O-ring 148 can be formed of a compliant yet resilient material such as rubber, latex, plastic, or other flexible substances, but it is not limited to such substances. Retaining ring 150 can be constructed of various substances including rubber, steel, aluminum, other metals, and various alloys, but ring 150 is generally associated with o-ring 148 in a commercially available sealing assembly that is known in the art.

Inner circumferential end 160 of drive plate 146 is shown proximate surface 162 of piston plate 118. The relationship between inner circumferential end 160 and surface 162 can be altered to accommodate the different substances that may be used in sealing assembly composed of 148 and 150, or 152. If the sealing assembly chosen to seal inner circumferential end 160 and surface 162 of piston plate 118 relies only upon an o-ring similar to o-ring 148 it may be appropriate to extend inner circumferential end 160 of drive plate 146 to contact surface 162 of piston plate 118, or nearly contact surface 162. However, it should be appreciate that numerous other sealing methods known in the art can be used to complete the seal between piston plate 118 and drive plate 146.

Bent segment 164 in drive plate 146 is formed in a shape shown to add resiliency and durability to drive plate 146 and the seal between drive plate 146 and piston plate 118, particularly inner circumferential end 160 and surface 162. The shape of bent segment 164 on drive plate 146 is also intended to give clearance for the axial movement of piston plate 118. Bent segment 164 can be various other shapes and the shape will be related to numerous factors that include but are limited to: the torque converter application, the resiliency needed in the drive plate, and on the clearance required for axial movement of the piston plate. It should be appreciated, that bent segment 164 can take on various other configurations, and thus it is considered within the spirit and scope of the invention to have drive plate 146 in various configurations prior to reaching the sealing surface 162 of piston plate 118. In some aspects, bent segment 164 can be eliminated entirely and drive plate 146 can be a flat plate, excluding the clutch engagement portion of plate 146, which should remain flexed or bent for clutch plate engagement.

FIG. 10 is an enlarged cross section of an alternative embodiment of drive plate 146 of the present invention, where drive plate 146 implements lip seal 152 to seal the pressure chamber on apply side 158 of piston plate 118 at surface 162. This alternative embodiment of drive plate 146 can be an annular component formed from a sheet steel blank that has been stamped into a plate having an L-shaped cross section profile. The shape, however, can be varied and it should be understood that variations the shape of drive plate 146 are considered within the spirit and scope of the invention. Where previous drive plates where welded to front cover 116 and remain flush with the interior surface of front cover 116, drive plate 146 extends toward the center of front cover 116 to surface 162 of piston plate 118. Fluid pressure on apply side 158 is sealed against leakage by lip seal 152 engaging surface 162 of piston plate 118. Lip seal 152 has a U-shaped cross section profile which enables lip seal 152 to envelop inner circumferential end 160 of drive plate 146. Lip seal 152 can be formed of a compliant yet resilient material such as rubber, latex, plastic, or other flexible substances, but it is not limited to such substances. For example lip seal 152 could take a form similar to that shown in FIG. 9 where a stiff ring is used to reinforce the seal. Such reinforcing rings can compensate for gaps between inner circumferential end 160 of drive plate 146 and surface 162 of piston plate 118. Tight interaction between inner circumferential end 160 and the interior surfaces of lip seal 152, and tight interaction between surface 162 and the exterior surface of lip seal 152, seals inner circumferential end 160 to surface 162 to form the pressure chamber on apply side 158. However, it should be appreciated that numerous other sealing methods known in the art can be used to complete the seal between piston plate 118 and drive plate 146.

In the alternative embodiment of drive plate 146 shown in FIG. 10, bent segment 164 can add resiliency to plate 146 and affords piston plate 118 sufficient clearance to move axially. Bent segment 164 can be configured in various other shapes that are not shown in FIGS. 9 and 10. One of ordinary skill in the art would understand that the clearance and resiliency concerns that need to be considered in forming drive plate 146 would permit numerous configurations that would be considered equivalent approaches to that disclosed here. In some aspects, multiple bends in bent segment 164 of drive plate 146 can be used, similar to the embodiment shown in FIG. 9, to accommodate a particular seal. However, it should be understood that drive plate 146 is not limited to any particular shape.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A clutch assembly in a torque converter, comprising:
a piston plate operatively arranged to apply axial pressure to a clutch in said clutch assembly;
an annular member rotationally connected to a cover of the torque converter and rotationally connected to an outer circumference of said clutch; and,
a first seal disposed between said piston plate and an inner circumference of said drive plate and forming a seal between said piston plate and said inner circumference.

2. The clutch assembly recited in claim 1, wherein said annular member is a drive plate arranged to transmit torque from said cover to said clutch.

3. The clutch assembly recited in claim 1, wherein said annular member is fixedly secured to said cover.

4. The clutch assembly recited in claim 3, wherein said annular member is welded to said cover.

5. The clutch assembly recited in claim 1 further comprising at least one first clutch plate with an outer circumference, wherein said annular member is rotationally connected to said at least one first clutch plate proximate said outer circumference.

6. The drive plate recited in claim 5, wherein said at least one first clutch plate is axially displaceable with respect to said annular member.

7. The clutch assembly recited in claim 1, wherein said piston plate is axially displaceable with respect to said annular member.

8. The clutch assembly recited in claim 1 wherein said clutch is a slipping clutch with a plurality of second clutch plates.

9. The clutch assembly recited in claim 8, wherein said plurality of second clutch plates is axially displaceable with respect to said annular member.

10. The clutch assembly recited in claim 1, wherein said piston plate further comprises an inner circumferential end, said torque converter further comprises a space between said cover and said piston plate and a second seal disposed proximate said inner circumferential end, and said first and second seals substantially seal said space.

11. The clutch assembly recited in claim 10, wherein said torque converter is arranged to modify pressure in said space to axially displace said piston plate.

12. The clutch assembly recited in claim 1, wherein said seal is selected from the group consisting of a U-shaped seal and an L-shaped seal.

13. The clutch assembly recited in claim 1, wherein said seal comprises rubber.

14. The clutch assembly recited in claim 1, wherein said seal comprises an o-ring.

15. A drive plate for a clutch in a torque converter, comprising:
an axially disposed segment rotationally connected to an outer circumference of said clutch and rotationally connected to a cover for said torque converter;
an inner circumferential end; and,
a sealing element disposed between said inner circumferential end and a piston plate engaged with said clutch and forming a seal between said inner circumferential end and said piston plate, wherein said drive plate is arranged to transmit torque from said cover to said clutch and said piston plate is arranged to axially engage said clutch.

16. A clutch assembly in a torque converter, comprising:
a piston plate operatively arranged to apply axial pressure to a clutch in said clutch assembly;
a drive plate fixedly secured to a cover of the torque converter, rotationally connected to an outer circumference of at least one clutch plate in said clutch, and comprising an inner circumference; and,
a seal disposed between said piston plate and said inner circumference and in contact with said piston plate and said inner circumference, wherein said piston plate is axially displaceable with respect to said annular member.
